(19) United States
(12) Patent Application Publication
(10) Pub. No.: US 2011/0055581 A1
(43) Pub. Date: Mar. 3, 2011

(54) HASH FUNCTION BASED ON PAINTING TECHNIQUES

(75) Inventors: Benoit CHEVALLIER-MAMES, Paris (FR); Mathieu CIET, Paris (FR); Augustin J. FARRUGIA, Cupertino, CA (US)

(73) Assignee: Apple Inc., Cupertino, CA (US)

(21) Appl. No.: 12/551,067

(22) Filed: Aug. 31, 2009

(51) Int. Cl. H04L 9/32

(52) U.S. Cl. 713/181

(57) ABSTRACT

In the computer data security field, this disclosure is of cryptographic hash function processes embodied in a computer system and which may be keyless, but are highly secure. The processes are based on the type of randomness exhibited by painting or drawing a picture. Computation of the hash value (digest) is the result of executing in computer code or logic circuitry an algorithm which models such a picture painting process using the message as an input to the picture painting algorithm, then executing the algorithm. A state of the resulting picture gives the hash digest value of the message. Message expansion or a derivation function (e.g., a pseudo random number generation process) may be applied to the message prior to execution of the picture painting process, for enhanced security.

### FIELD OF THE INVENTION

This invention relates to computers, computer data security, and hash functions (hashing).

### BACKGROUND

Hash functions are well known in the field of data security. The principle is to take data (a digital message, digital signature, etc.) and use it as an entry to a hash function resulting in an output called a “digest” of predetermined length which is intended to uniquely identify (“fingerprint”) the message. A secure (cryptographic) hash is such that any alteration in the message results in a different digest, even though the digest is much shorter than the message. Such hash functions are “collision-resistant” and “one-way.”

Cryptography and data security deal with digital signatures, encryption, document authentication, and hashing. In all of these fields, there is a set of basic tools/functions which are widely used, for instance hash functions. Several properties are required for the use of hash functions in cryptographic applications: preimage resistance, second preimage resistance and collision resistance.

In the recent years, much energy has been expended finding new hash functions, since collisions (weaknesses or successful attacks) have been found in the widely used SHA-1 standard hash.

### SUMMARY

Disclosed here is a new type of cryptographic (secure) hash function or process. The goal is a modular hash function that is also computationally efficient (fast). The present hash function can conventionally be used for document integrity for exchanges and signatures. It can be also used as a derivation function or as a HMAC (hash message authentication code) by adding a key conventionally (as in for instance the well known HMAC-SHA1) and the term “hash” as used herein is intended to encompass all these uses, both keyed and non-keyed.

A hash function is a deterministic procedure that accepts an arbitrary input value, and returns a hash value. The input value is called the message, and the resulting output hash value is called the digest. The message is authenticated by comparing the computed digest to an expected digest associated with the message.

This disclosure is of a new kind of hash function, based on the principle of painting techniques. Consider a conventional picture painting or drawing process (either with actual paint and paper or canvas, or computer graphics type painting), which starts with an e.g., all-white picture (in one example) represented here as an array of pixels. Then, depending on the words (data) of the message, one chooses a notional painting technique from a certain predetermined number of available painting techniques, and uses the chosen technique to update (“paint”) the notional picture. At the end of the process, when all the message words have been used, certain of the pixels of the finally-obtained notional picture are extracted, in order to provide the hash digest.

The advantage of this solution compared to existing hash functions is the relative ease of implementation and the throughput performance.

The present process can be described as follows. Consider a notional picture as a two dimensional array of pixels (picture elements), called Painting and consisting of PAINTING_HEIGHT number of pixels in the ordinates (second axis) and PAINTING_WIDTH number of pixels in the abscissa (first axis). Depending on the number of desired notional colors, each pixel can be either bits (for black and white), or bytes or words or whatever bit-size. Each pixel is represented by one entry in the array.

One then defines a certain number of notional painting or drawing techniques, some of which relate to modern art or computer graphics. Notably, consider the following possibilities for the notional painting techniques (but this list is not limiting): cutting parts: one cuts or copies a part of the picture, and pastes it somewhere else on the picture; rotating parts: one selects a part of the picture, and rotates it by several degrees; overlining: one draws a line with a color brush; superimposing: one cuts or copies a part of the picture; and superimposes it on another part of the picture, using some transparency effects; ink jetting: one takes a “pen” of a particular color, and “throws” ink over the picture; drawing geometric figures: one draws a square, a circle and any other geometric (or non-geometric) figure in a certain color with a given (or not) contour color.

Here no actual painting is drawn or painted or even displayed on a computer display in accordance with the invention and there is no actual painter. Instead a notional painting process (where “painting” includes drawing or similar activities) is modeled mathematically, without an artist or any actual computer graphics display. In accordance with the present hash function, there is no introduction of randomness from a user or painter since the way the notional painting is painted (modeled) is uniquely determined by the input (the message to be hashed) in one embodiment. This means that the hash function disclosed here is completely deterministic. The notional painting process is or includes any one of the above described painting/drawing techniques or others or variants thereof; it does not need to conform to any actual painting/drawing techniques.

The present approach is based on the observation that actual paintings or drawings exhibit a high degree of chaos in the way the final painting appears. The present goal is to use the principles of such painting techniques to compute a hash function since such a chaotic (randomness) characteristic is a key feature to provide a secure hash function. In this sense “secure” means strongly one way, meaning that given a message it is easy to compute the digest, but it is very difficult to find a message that returns a given digest.

Since actual painting/drawing techniques are well known and exist in many variants, programming details of the present painting modeling algorithm (which models painting or drawing as a process in accordance with the invention) are given here in one exemplary embodiment. Writing computer code (or designing equivalent logic circuitry) for variants would be routine to one skilled in the art in light of this disclosure. Moreover the present hash function is computed very rapidly in computer software (or hardware—dedicated logic circuitry). For instance, a hash “digest” as used when transferring data requires fast determination of the digest. This hash function is especially useful when transferring large amounts of data.

Note that terms such as “pixels,” “painting,” “colors,” “white,” “picture,” “techniques,” “black,” “copy,” “paste,” “rotate,” “overline,” “draw,” “line,” “brush,” “ink,” “draw,” “figure,” etc. used here in connection with the present invention do not refer to any physical object or manipulation thereof or person or any actual depiction of same even on a computer or game display, but are notional and refer instead to values, identifiers, or variables used in computer code or logic to compute a hash function or equivalent, and are used only for convenience of understanding herein as referring conceptually to analogous aspects of the above described painting process.

### BRIEF DESCRIPTION OF THE FIGURES

FIG. 1 shows a set of variables and parameters.

FIG. 2 shows relevant portions of a computing device for carrying out the present method.

FIG. 3 shows additional detail of the FIG. 2 computing device.

### DETAILED DESCRIPTION

In the present computer based model of a painting process, some or all of the above painting techniques are “simulated” (modeled), by using computer software or a hardware counterpart. Consider an example using a model of the above described techniques (which it is emphasized are just examples, and can be expanded upon) which includes in more detail the following techniques: Cutting parts: this is simply transferring a copy of a part of the Painting array to another part of the same array. Rotating parts: rotations of, e.g., 90, 180 or 270 degrees are the simplest to simulate and this involves moving some part of the Painting array to other locations in the array. Overlining (non-transparent): one replaces some pixels of the array with the chosen color. Overlining (transparent): one logically combines, using e.g. a Boolean XOR operation, some pixels of the array with the chosen color. Superimposing: one cuts a part of the picture, and logically combines, using e.g. the Boolean XOR operation, over another part of the picture. Ink jetting: one selects a line between two points A and B of the picture array, and replaces or logically XORs (depending on the transparency effect) some of the points between A and B with the ink color. This simulates an ink jet. Drawing geometric figures: one draws a square, a circle or other geometric (or non-geometric) figure in a certain color in the array. Note that both conventional painting/drawing techniques and computer graphics techniques may be modeled.

Before using the message as the selection mechanism of the painting techniques to apply on the virgin (e.g., white) picture, in some embodiments one first performs what is called in cryptography a message expansion or a derivation function. The goal with the expansion is to take the message, and to alter it, e.g. expand it into a much more longer data array including possibly multiple copies of the original message, possibly some prefix and suffix constants, with possibly some transformation of the data, etc. An example of a derivation function is to use the message as the seed value for a conventional pseudo random number generator, and use the resulting random numbers as the input to the hash function rather than the message itself. The reason for use of the expansion or of the use of a seeded PRNG (or other derivation function) is to avoid the situation that the painting techniques selected are too much under the control of a known message attacker. With message expansion or PRNG use, when the attacker changes a part of the message, this changes a larger part of the expanded message, and so effects are much more complicated for the attacker to control, thereby defeating the attack.

After the message has been expanded or subject to the derivation function, one employs all the bytes/words of the expanded or altered message as a kind of “entropy tank”. One thereby uses the expanded or altered message to decide which of the painting techniques to use, and with which parameter (such as colors of the drawing, positions of the forms or copies or cuts, sizes etc). Depending on the particular painting technique, the number of parameters is variable.

Once all the bytes or words of the expanded (or altered) message have thereby been used to notionally paint the picture, one finishes the hash computation process by conventionally selecting some of the pixels of the final notional picture as the digest (this is also referred to as the extraction process). This selection can have many possible implementations, as well known in the field.

A pseudo-code implementation of this hash function process using message expansion is as follows and conventionally is structured like actual (executable) software code but less detailed and is in the form of the C computer language:

```
/* Initialise the painting */
for (i = 0; i < PAINTING_WIDTH; i++)
{
    for (j = 0; j < PAINTING_HEIGHT; j++)
    {
        Painting[i][j] = COLOR_WHITE;
    }
}
/* Expand the message */
ExpandMessage(Message, ExpandedMessage);
/* Apply several times some different painting techniques */
for (k = 0; k < (SizeOf(ExpandedMessage) −
NB_MAX_PARAM_PER_DRAW_TECHNIQUE);)
{
    // Take a technique of painting
    Technique = ExpandMessage[k] % NB_TECH;
    k++;
    // Apply the technique. Increment the k counter by the number of
    // parameters used by the technique
    k = k+ ApplyTheTechnique(Technique, ExpandMessage, k);
}
/* Extract the output */
ExtractHashValueFromPicture(Painting, HashValue,
HASH_VALUE_LENGTH);
```

Here “/*” and “*/” denote a non-compilable comment, as does “//”. “%” is the modulo operator. “++” means increment by one. In other embodiments, the message expansion as explained above is replaced with, e.g., a seeded PRNG, the implementation of which would be conventional and readily coded. More generally, a derivation function of any type with good distribution properties may be used in place of message expansion.

In terms of the functions in this pseudo code, ExpandMessage is a function taking the input message which is designated Message and computing the expanded message which is designated ExpandedMessage. The size of the expanded message is given by the call to SizeOf(ExpandedMessage). COLOR_WHITE is a constant defining e.g. the white (initial) color of the pixels. NB_TECH is a constant indicating the number of available painting techniques. These techniques are numbered from 0 to NB_TECH-1. The more techniques available, the higher the level of security. ApplyTheTechnique is a function applying the selected painting technique designated Technique, i.e. which simulates (models) the notional painting technique with a computer based equivalent, as described above. Notably, this function uses the expanded message array ExpandedMessage in order to obtain some parameters, such as colors, locations, and sizes. It also uses the counter k, in order to see from where it has to take its fresh parameters. At the end, function ApplyTheTechnique returns a number, defining how many such bytes have to be used in order to update the k value.

NB_MAX_PARAM_PER_DRAW_TECHNIQUE is a constant defining how many parameters are used in the ApplyTheTechnique function maximally. In other words, it is an upper bound of the outputs of the ApplyTheTechnique function. Finally, ExtractHashValueFromPicture is a function which takes the Painting array and extracts HASH_VALUE_LENGTH number of bytes of information as the digest which is then stored in a buffer (memory or storage) designated HashValue. Note that coding the individual painting techniques would be routine, since each as described above is a relatively simple data manipulation.

There are numerous variants of this hash function. Of course, one can use other painting techniques and their modeled equivalents in some variants. One can also implement a variety of message expansion or derivation function techniques in addition to those described above. It is also possible to modify the way the main control loop of the hash function operates; instead of using the control loop expressed in the pseudo code as (k=0; k<(SizeOf(ExpandedMessage)−NB_MAX_PARAM_PER_DRAW_TECHNIQUE);) one could instead use another kind of loop, with a more variable number of iterations. One could also reuse some of the words of the expanded message twice or more, instead of using them only once.

Other variants will be apparent to one skilled in cryptography.

This disclosure only depicts the basic principle and the invention is not limited to the present examples. Advantages compared to previous hash functions are the large number of possible variants and also the ease of implementation as shown in this illustrative description. In other variants, for instance, when introducing geometric or other figures, one could have figures (circles, etc.) with borders (contours) of other colors.

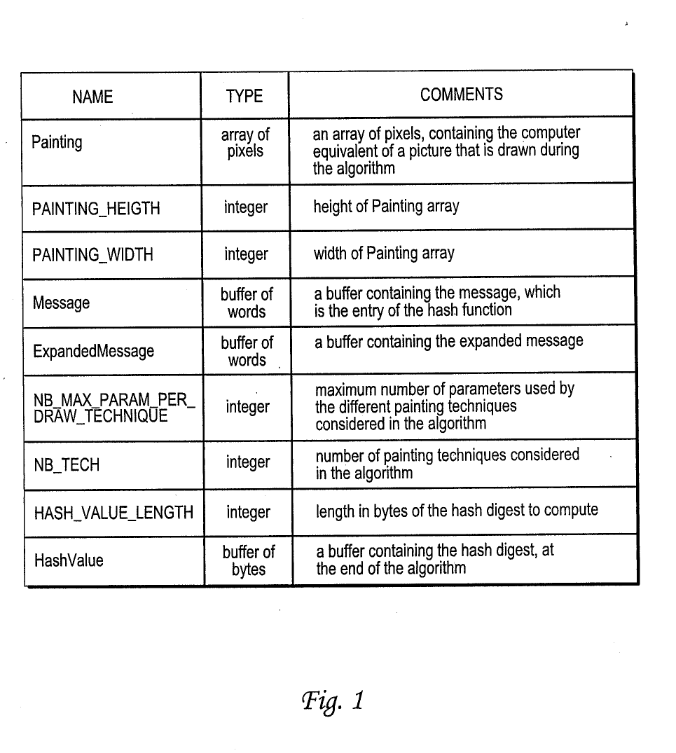

FIG. 1 shows detail of the variables and parameters of the above pseudo code with description of the type and comments.

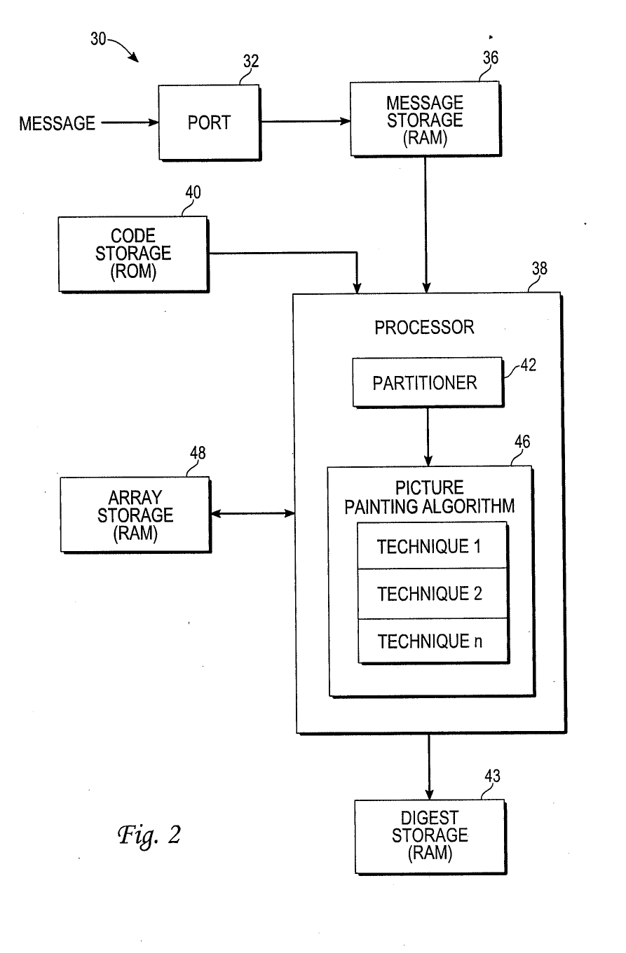

FIG. 2 shows in a block diagram relevant portions of a computing device (system) 30 in accordance with the invention. This is, e.g., a server platform, computer, mobile telephone, Smart Phone, personal digital assistant or similar device, or part of such a device and includes conventional hardware components executing in one embodiment software (computer code) as represented by the above pseudo-code example. This code may be, e.g., in the C or C++ computer language or its functionality may be expressed in the form of firmware or hardware logic; writing such code or designing such logic would be routine in light of the above pseudo code. Of course, the above pseudo code example is not limiting.

The computer code is conventionally stored in code memory (computer readable storage medium) 40 (as object code or source code) associated with conventional processor 38 for execution by processor 38. The incoming message (in digital form) is received at port 32 and stored in computer readable storage medium (memory) 36 where it is coupled to processor 38. Processor 38 conventionally partitions the message into suitable sized blocks at partitioning module 42. Certain of the software (code) modules in storage 40 make up the picture painting algorithm module 46 executed by processor 38 and which carries out the pseudo code functionality set forth above. Storage (buffer) 48 stores the array Painting.

Also coupled to processor 38 is a fourth storage 43 for the resulting extracted hash digest. The hash digest is conventionally extracted from the array storage 48, for instance as n consecutive entries so as to provide a hash digest of sufficient fixed length. One can perform this extraction in various ways, so as to extract the needed number of bytes for the digest from the final state of the array 48. Storage locations 36, 43, 48 may be in one or several conventional physical memory devices (such as semiconductor RAM or its variants or a hard disk drive).

Electric signals conventionally are carried between the various elements of FIG. 2. Not shown in FIG. 2 is the subsequent conventional use of the resulting hash digest stored in storage 43, which is compared by processor 38 to a second expected hash digest value associated with the incoming message. Only if the two hash digest values match is the incoming message (a digital document, digital signature or similar information) authenticated.

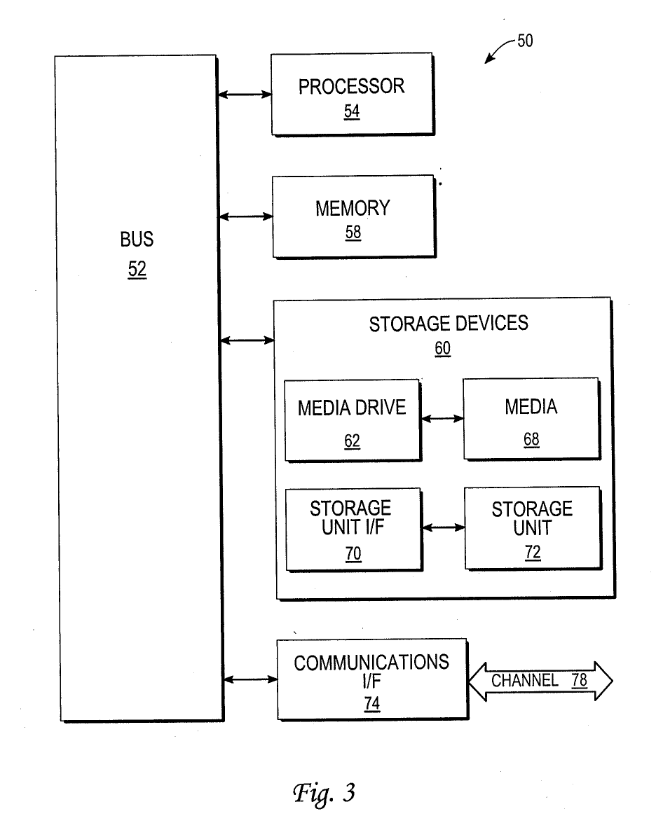

FIG. 3 shows further detail of the FIG. 2 computing device in one embodiment. FIG. 3 illustrates a typical and conventional computing system 50 that may be employed to implement processing functionality in embodiments of the invention and shows additional detail of the FIG. 2 system. Computing systems of this type may be used in a computer server or user (client) computer or other computing device, for example. Those skilled in the relevant art will also recognize how to implement embodiments of the invention using other computer systems or architectures. Computing system 50 may represent, for example, a desktop, laptop or notebook computer, hand-held computing device (personal digital assistant (PDA), cell phone, palmtop, etc.), mainframe, server, client, or any other type of special or general purpose computing device as may be desirable or appropriate for a given application or environment. Computing system 50 can include one or more processors, such as a processor 54 (equivalent to processor 38 in FIG. 2). Processor 54 can be implemented using a general or special purpose processing engine such as, for example, a microprocessor, microcontroller or other control logic. In this example, processor 54 is connected to a bus 52 or other communications medium. Note that in some embodiments the present process is carried out in whole or in part by “hardware” (dedicated circuitry) which is equivalent to the above described software embodiments.

Computing system 50 can also include a main memory 58 (equivalent to memories 36, 40, 48 in FIG. 2), such as random access memory (RAM) or other dynamic memory, for storing information and instructions to be executed by processor 54. Main memory 58 also may be used for storing temporary variables or other intermediate information during execution of instructions to be executed by processor 54. Computing system 50 may likewise include a read only memory (ROM) or other static storage device coupled to bus 52 for storing static information and instructions for processor 54.

Computing system 50 may also include information storage system 60, which may include, for example, a media drive 62 and a removable storage interface 70. The media drive 62 may include a drive or other mechanism to support fixed or removable storage media, such as flash memory, a hard disk drive, a floppy disk drive, a magnetic tape drive, an optical disk drive, a compact disk (CD) or digital versatile disk (DVD) drive (R or RW), or other removable or fixed media drive. Storage media 68 may include, for example, a hard disk, floppy disk, magnetic tape, optical disk, CD or DVD, or other fixed or removable medium that is read by and written to by media drive 62. As these examples illustrate, the storage media 68 may include a computer-readable storage medium having stored therein particular computer software or data.

In alternative embodiments, information storage system 60 may include other similar components for allowing computer programs or other instructions or data to be loaded into computing system 50. Such components may include, for example, a removable storage unit 72 and an interface 70, such as a program cartridge and cartridge interface, a removable memory (for example, a flash memory or other removable memory module) and memory slot, and other removable storage units 72 and interfaces 70 that allow software and data to be transferred from the removable storage unit 72 to computing system 60.

Computing system 60 can also include a communications interface 74 (equivalent to port 32 in FIG. 2). Communications interface 74 can be used to allow software and data to be transferred between computing system 50 and external devices. Examples of communications interface 74 can include a modem, a network interface (such as an Ethernet or other network interface card (NIC)), a communications port (such as for example, a USB port), a PCMCIA slot and card, etc. Software and data transferred via communications interface 74 are in the form of signals which can be electronic, electromagnetic, optical or other signals capable of being received by communications interface 74. These signals are provided to communications interface 74 via a channel 78. This channel 78 may carry signals and may be implemented using a wireless medium, wire or cable, fiber optics, or other communications medium. Some examples of a channel include a phone line, a cellular phone link, an RF link, a network interface, a local or wide area network, and other communications channels.

In this disclosure, the terms “computer program product,” “computer-readable medium” and the like may be used generally to refer to media such as, for example, memory 58, storage device 68, or storage unit 72. These and other forms of computer-readable media may store one or more instructions for use by processor 54, to cause the processor to perform specified operations. Such instructions, generally referred to as “computer program code” (which may be grouped in the form of computer programs or other groupings), when executed, enable the computing system 50 to perform functions of embodiments of the invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 50 using, for example, removable storage drive 72, drive 62 or communications interface 74. The control logic (in this example, software instructions or computer program code), when executed by the processor 54, causes the processor 54 to perform the functions of embodiments of the invention as described herein.

This disclosure is illustrative and not limiting. Further modifications will be apparent to these skilled in the art in light of this disclosure and are intended to fall within the scope of the appended claims.

We claim:

1. A hashing method performed by a computing apparatus and comprising the acts of:
(a) receiving a message at an input port;
(b) storing the received message as an array having a plurality of entries in a first computer readable storage medium coupled to the input port;
(c) a processor coupled to the first computer readable storage and modifying the array, according to a picture painting algorithm stored in a second computer readable medium coupled to the processor;
(d) the processor updating the array stored in the first computer readable storage according to act (c);
(e) using the updated array resulting from act (d) to provide a hash value of the message; and
(f) the processor storing the hash value in a third computer readable storage medium coupled to the processor.

2. The method of claim 1, wherein act (c) includes modeling a plurality of painting techniques, and selecting one of the painting techniques as a function of the message, or of a value derived from the message.

3. The method of claim 1, further comprising expanding the received message or using a pseudo random number generator seeded with the message.

4. The method of claim 1, wherein act (b) further includes partitioning the message into a plurality of blocks.

5. The method of claim 2, wherein the painting techniques include cutting and pasting, copying, rotating, overlining, superimposing, ink jetting, and drawing geometric figures.

6. The method of claim 1, further comprising the acts of:
receiving a hash value associated with the message at the processor;
comparing the received hash value to the stored hash value of act (g); and
authenticating the message if the comparison indicates a match.

7. The method of claim 1, wherein the message is one of a digital signature or document, a digital message, a secret key or an identifier.

8. The method of claim 1, wherein the picture painting algorithm models a picture as a two dimensional array of elements, each element representing a pixel.

9. The method of claim 1, wherein each entry in the array is one bit of data, one byte of data, one 16-bit word, one 32-bit word, one 64-bit word or one 128-bit word.

10. The method of claim 5, wherein the picture painting algorithm includes defining a parameter indicating a number of the plurality of techniques that are available.

11. The method of claim 1, wherein act (f) includes extracting the hash value from the array.

12. A computer readable medium storing computer code instructions for executing the method of claim 1 on the computing apparatus.

13. A computing apparatus programmed to carry out the method of claim 1.

14. An apparatus for computing a hash, comprising:
(a) an input port for receiving a message;
(b) a first computer readable storage medium coupled to the input port for storing the received message as an array having plurality of entries; and
(c) a processor coupled to the first storage medium and which modifies entries for the array according to a picture painting algorithm;
(d) wherein the processor updates the array according to (c);
(e) wherein the processor uses the updated array to provide a hash value of the message; and
(f) wherein the processor stores the hash value in a second computer readable storage medium coupled to the processor.

15. The apparatus of claim 14, wherein (c) includes modeling a plurality of painting techniques, and selecting one of the painting techniques as a function of the message, or of a value derived from the message.

16. The apparatus of claim 14, further comprising expanding the received message or seeding a pseudo random number generator with the message.

17. The apparatus of claim 14, wherein (b) further includes partitioning the message into a plurality of blocks.

18. The apparatus of claim 15, wherein the painting techniques include cutting and pasting, copying, rotating, overlining, superimposing, ink jetting, and drawing geometric figures.

19. The apparatus of claim 14, further comprising:
receiving at the processor from the port a hash value associated with the message;
comparing at the processor the received hash value to the stored hash value of (g); and
authenticating the message if the comparison indicates a match.

20. The apparatus of claim 14, wherein the message is one of a digital signature or document, a digital message, a secret key or an identifier.

21. The apparatus of claim 14, wherein the picture painting algorithm models a picture as a two dimensional array of elements, each element representing a pixel.

22. The apparatus of claim 14, wherein each entry in the array is one bit of data, one byte of data, one 16-bit word, one 32-bit word, one 64-bit word or one 128-bit word.

23. The apparatus of claim 14, wherein the picture painting algorithm includes defining a parameter indicating a number of the plurality of techniques that are available.

24. The apparatus of claim 14, wherein (e) includes extracting the hash value from the array.
